(19) United States
(12) Patent Application Publication
(10) Pub. No.: US 2020/0263643 A1
(43) Pub. Date: Aug. 20, 2020

(54) FUEL LINE, CONNECTION PIECE AND FUEL SUPPLY SYSTEM

(71) Applicant: Vitesco Technologies GmbH, Hannover (DE)

(72) Inventors: Hans-Guenter Benner, Schwalbach a. Ts. (DE); Matthias Kadler, Schwalbach a. Ts. (DE)

(21) Appl. No.: 16/755,421

(22) PCT Filed: Oct. 23, 2018
(86) PCT No.: PCT/EP2018/078955

§ 371 Date: Apr. 10, 2020

(30) Foreign Application Priority Data
Oct. 26, 2017 (DE) 10 2017 219 262.3

(51) Int. Cl. F02M 37/00; B60K 15/01

(52) U.S. Cl. CPC F02M 37/0017; B60K 2015/016; F02M 37/0052; B60K 15/01

(57) ABSTRACT

A fuel line for use in a fuel-carrying vehicle designed as a one-piece multi-chamber line having at least two separate fuel-carrying lines each forming a chamber. A first chamber carries fuel in a first flow direction and a second chamber carries fuel in the first or a second flow direction. Also proposed is a correspondingly adapted connection piece for joining to such a multi-chamber line.

### CROSS REFERENCE TO RELATED APPLICATIONS

This is a U.S. national stage of Application No. PCT/EP2018/078955 filed Oct. 23, 2018. Priority is claimed on German Application No. DE 10 2017 219 262.3 filed Oct. 26, 2017 the content of which is incorporated herein by reference.

### BACKGROUND OF THE INVENTION

### 1. Field of the Invention

The present invention relates to a fuel line and to a connection piece for joining to such a fuel line for use in a fuel-carrying vehicle and also to a fuel supply system having at least one such fuel line and at least one such connection piece. A “vehicle” is to be understood here as meaning in principle any type of vehicle which has to be supplied with a liquid and/or gaseous fuel for operation, but in particular passenger cars and/or commercial vehicles.

### 2. Description of Related Art

In the automotive field, a fuel is carried both inside and outside a fuel tank in fuel lines which each carry the fuel exclusively in one flow direction, for instance toward an internal combustion engine or toward an anti-surge pot arranged inside the fuel tank. Here, the fuel lines installed in a vehicle generally require two separate connections in each case. In other words, both ends of such a fuel line require a respective separate connection. Overall, there is accordingly at least substantially required a number of connections which is double the number of fuel lines.

### SUMMARY OF THE INVENTION

One aspect of the invention is reducing to a minimum the number of such fuel lines and connections joined to the fuel lines in a fuel supply system.

One aspect of the invention is reducing a cost of such a fuel supply system.

One aspect of the invention is the below-proposed type of a fuel line and of a connection piece for joining to the fuel line.

A fuel line for use in a fuel-carrying vehicle is proposed. The fuel line is configured as a one-piece multi-chamber line having at least two mutually separated fuel-carrying lines which each form a chamber, wherein a first chamber carries a fuel in a first flow direction, whereas a second chamber carries the fuel in the first flow direction or in a second flow direction opposite to the first flow direction.

A “fuel line” is understood as meaning a flexible or rigid pipe or a hose that is flexible by its very nature, for instance in the form of a plastic or rubber hose. A contribution to the flexibility of the fuel line can be made not only by a suitable material choice but also for example by the formation of a wavy shape at least in certain portions, with the result that the fuel line can take the form of a corrugated pipe or a corrugated hose either in certain portions or at least substantially completely.

“Mutually separated fuel-carrying lines” are understood as meaning that the individual lines formed by the respectively assigned chambers are continuously separated from one another over their longitudinal extent.

Using the fuel lines of the proposed type makes it possible to reduce to a minimum a number of fuel lines installed in a vehicle. This is also accompanied by a reduction of corresponding connections for the fuel lines, since the individual fuel-carrying lines each have a connection piece in common at both ends of such a fuel line. In this respect, the proposed fuel line also contributes to a reduction in a large number of parts. This in turn is associated with a reduction in the costs of a fuel supply system, also including storage costs, and furthermore with a reduction in assembly effort.

According to one aspect of the present invention, the fuel line has at least three mutually separated fuel-carrying lines which each form a chamber. In principle, however, the number of these lines can be chosen freely depending on the requirement.

In order to avoid faulty connections, it is proposed to asymmetrically subdivide the cross section of the fuel line into the individual chamber cross sections so as to represent the so-called poka-yoke principle. The Japanese expression poka-yoke (avoiding unfortunate errors) refers to a principle which is made up of a number of elements and which comprises technical measures or devices for immediate error detection and prevention.

The cross section of the fuel line can here be formed in any desired manner, thus for example being circular, semicircular, oval, semi-oval, triangular, square, rectangular or half-moon-shaped. Equally, the cross sections of the individual chambers can be formed in any desired manner, thus for example being circular, semicircular, oval, semi-oval, triangular, square, rectangular, or half-moon-shaped. The walls between the individual chambers can here have equal and/or unequal thicknesses.

According to a further aspect of the present invention, the fuel line can be manufactured by extruding a plastic to form the individual chambers. Moreover, the fuel line can be configured to be antistatic, with the fuel line having at least one electrically conductive strip for dissipating a static charge to ground potential. It is possible here for example for each chamber to be assigned at least one such strip.

The electrically conductive strip extends, for example, over an entire length of the fuel line. Here, the electrically conductive strip can be oriented in the longitudinal direction of the fuel line, especially since this too contributes to minimizing the required electrically conductive material.

According to one aspect of the present invention, the electrically conductive strip can be formed as an integral component part of a co-extruded plastic pipe, with the strip being formed from an electrically conductive plastic. Such a configuration reduces the large number of components required for dissipation. Moreover, it is possible here to reduce to a minimum the amount of the required electrically conductive material by comparison with the total material required for producing the fuel line. Furthermore, the electrically conductive material is concentrated along this strip. Electrically conductive plastics suitable for such an application are known to a person skilled in the art, such as for example the thermoplastic material POM HOSTAFORM EC140XF or Tenac-C EF450. These are therefore not discussed in further detail below.

In addition or alternatively, an electrically conductive strip can be printed onto the fuel line. Printable electrically conductive materials suitable for such an application are known to a person skilled in the art. These materials are therefore not discussed in further detail below.

In addition or alternatively, an electrically conductive strip, for example in the form of a metallic strip, can be adhesively bonded onto the fuel line. Adhesively bondable metallic materials suitable for such an application, such as in the form of a metallic adhesive strip, are known to a person skilled in the art. These materials are therefore not discussed in further detail below.

Also proposed is a connection piece for joining to a fuel line or multi-chamber line of the above-described type. The connection piece can here be joined to a single fuel line or to a plurality of fuel lines of the above-described type.

The connection piece here comprises at least a first fuel-carrying connection piece pipe section and a second fuel-carrying connection piece pipe section, wherein the two connection piece pipe sections are spaced apart from one another and integrally formed on a common connection piece base section.

In the connection piece base section there are here formed at least two mutually separated fuel-carrying lines into which the respective, assigned connection piece pipe sections open, wherein the first connection piece pipe section, in conjunction with the assigned first line, carries a fuel in a first flow direction, whereas the second connection piece pipe section, in conjunction with the assigned second line, carries the fuel in the first flow direction or in a second flow direction opposite to the first flow direction.

According to one aspect of the present invention, the connection piece comprises at least a first, a second, and a third fuel-carrying connection piece pipe section, wherein the individual connection piece pipe sections are spaced apart from one another and open into an assigned fuel-carrying line of the connection piece base section.

Analogously to the above-described fuel line, the cross sections of the individual connection piece pipe sections can be designed to be asymmetrical to one another in order to represent the aforementioned poka-yoke principle. The cross sections can here be circular, semicircular, oval, semi-oval, triangular, square, rectangular or half-moon-shaped. It is also possible in principle for the lines within the connection piece base section to have any desired cross-sectional shape.

According to a one aspect of the present invention, the connection piece is integrally formed on a flange, which closes an opening of a fuel tank, of a fuel delivery unit.

Additionally proposed is a fuel supply system of a vehicle, wherein the fuel supply system has at least one fuel line and at least one connection piece of the above-described type.

### BRIEF DESCRIPTION OF THE DRAWINGS

The invention will be explained in detail in the following text with reference to the illustrations in the figures. Further advantageous developments of the invention will emerge from the dependent claims and the following description of preferred embodiments. In the figures:

FIG. 1 is a filling level transmitter, configured as a suction unit according to the prior art for use in a fuel tank;

FIG. 2 is the suction unit shown in FIG. 1 with a proposed fuel line; and

FIGS. 3A and 3B are a connection piece for joining to a proposed fuel line in a perspective view and in a side view.

### DETAILED DESCRIPTION OF THE PRESENTLY PREFERRED EMBODIMENTS

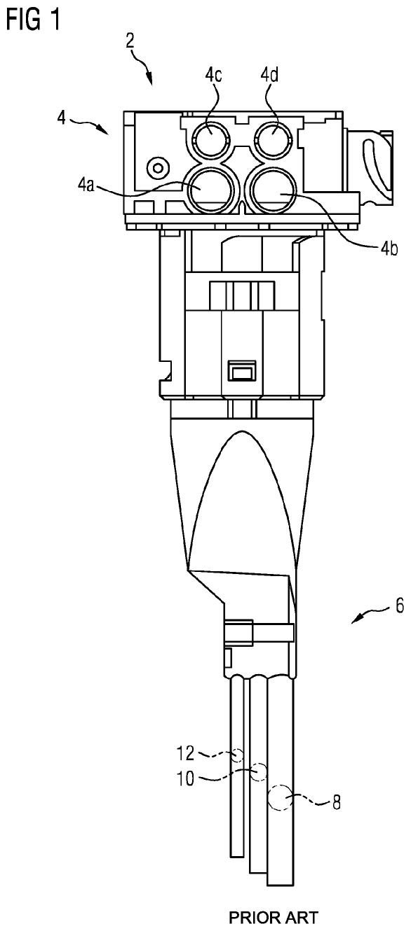

FIG. 1 illustrates part of a suction unit 2, also termed supply transmitter, known according to the prior art for the tank filling level measurement of in particular commercial and special vehicles. The suction unit 2 comprises a fastening and connection section 4 which, on the one hand, can be fastened to a fuel tank via a bayonet flange (not shown here) and, on the other hand, provides a total of four connections 4a, 4b, 4c, 4d for fuel-carrying lines.

The suction unit 2 together with bayonet flange here closes an opening of the fuel tank from which the suction unit 2 dips into the fuel tank. Here, the three illustrated, separate fuel lines 8, 10, 12 extend from a respective assigned connection of a connection section 6 to a region of the fuel tank close to the bottom. The first fuel line 8 is here in fluidic communicative connection with a first connection 4a of an engine feed line, whereas the second fuel line 10 is in fluidic communicative connection with a second connection 4b of an engine return line. By contrast, the third fuel line 12 is in fluidic communicative connection with a third connection 4c of a feed line of an auxiliary heater. A return of the auxiliary heater is ensured via a fourth connection 4d, with no separate fuel line extending from the connection 4d into the fuel tank being provided for the return of the auxiliary heater into the fuel tank.

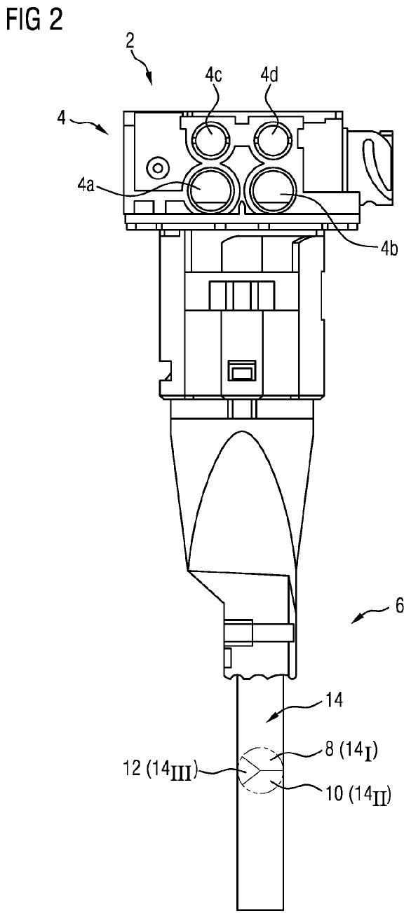

The proposed suction unit 2 as per FIG. 2 differs in relation to the illustration in FIG. 1 by virtue of the fuel line 14 which is designed as a one-piece multi-chamber line having three mutually separated fuel-carrying lines 8, 10, 12, wherein the individual lines 8, 10, 12 each form a chamber 14_{I}, 14_{II}, 14_{III}. The first chamber 14_{I} here forms the first fuel line 8 mentioned above with regard to FIG. 1, whereas the second chamber 14_{II} forms the aforementioned second fuel line 10, and the third chamber 14_{III} forms the aforementioned third fuel line 12.

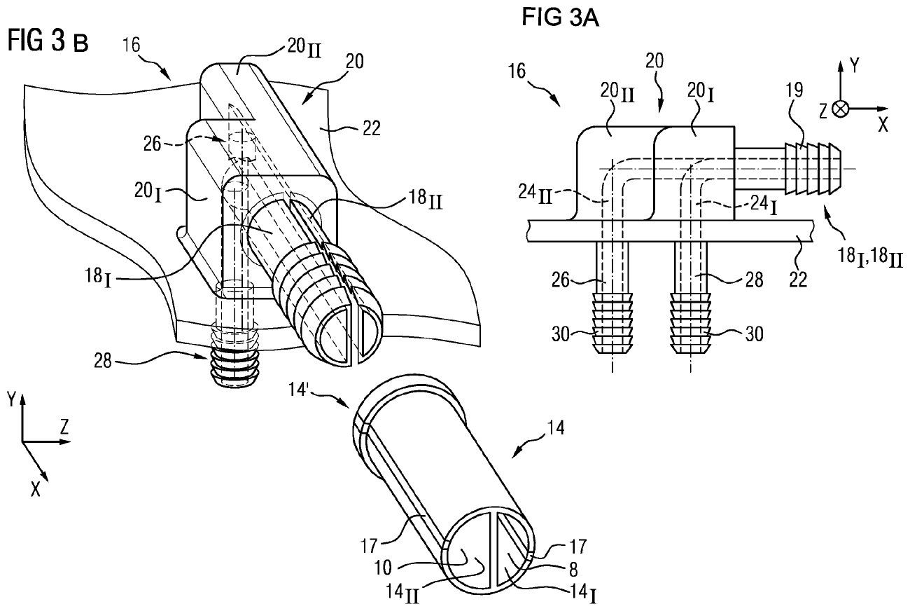

FIGS. 3A and 3B illustrate a connection piece 16 for joining to a one-piece two-chamber line 14. The connection piece 16 is integrally formed, for example by injection-molding, on a flange 22 of a fuel delivery unit. In its use position, the flange 22 here closes an opening of a fuel tank through which the fuel delivery unit is inserted into the fuel tank. The connection piece 16 comprises a first fuel-carrying connection piece pipe section 18_{I} and a second fuel-carrying connection piece pipe section 18_{II}, wherein the two connection piece pipe sections 18_{I}, 18_{II} are for example spaced apart from one another over their entire longitudinal extent and integrally formed on a common connection piece base section 20, 20_{I}, 20_{II}. At the end facing away from the connection piece base section 20, 20_{I}, 20_{II}, the two connection piece pipe sections 18_{I}, 18_{II} are each provided with a fir tree profile. Two mutually separated fuel-carrying lines 24_{I}, 24_{II} into which the respective, assigned connection piece pipe sections 18_{I}, 18_{II} open are formed in the connection piece base section 20, which forms two sections 20_{I}, 20_{II} which are offset with respect to one another in the X-X longitudinal direction as shown in FIG. 3A, which is a perspective view. Two line sections 26, 28 each having a fir tree profile 30 and into which the respective, assigned lines 24_{I}, 24_{II} open are integrally formed, for example by injection-molding, on the side of the flange 22 that faces away from the connection piece 16.

The first connection piece pipe section 18_{I}, in conjunction with the assigned first line 24_{I} and the line section 28, can carry a fuel in a first flow direction, whereas the second connection piece pipe section 18_{II}, in conjunction with the assigned second line 24_{II} and the line section 26, carries the fuel in the first flow direction or in a second direction opposite to the first flow direction. Whereas, for example, the connection piece pipe section 18_{I}, the line 24_{I} and the line section 28 can be in fluidic flow connection with an engine feed line, the connection piece pipe section 18_{II}, the line 24_{II} and the line section 28 can be in fluidic flow connection with an engine return line.

The cross sections of the two connection piece pipe sections 18_{I}, 18_{II} are advantageously designed to be asymmetrical to one another so as to prevent incorrect joining to the two-chamber line 14 which forms the two chambers 14_{I}, 14_{II}, according to the aforementioned “poka-yoke” principle. The two chambers 14_{I}, 14_{II} are here formed in terms of their cross section so as to correspond to the shaping of the respectively assigned connection piece pipe sections 18_{I}, 18_{II}.

Moreover, the two-chamber line 14 is advantageously configured to be antistatic. For this purpose, for example, each of the two chambers 14_{I}, 14_{II} is assigned an electrically conductive strip 17 for dissipating a static charge to ground potential, wherein the two strips 17 extend for example over the entire length of the two-chamber line 14 and are here oriented in the longitudinal direction of the two-chamber line 14. The strips 17 are formed for example as an integral component part of a co-extruded plastic line.

In a further embodiment, it is additionally or alternatively possible for at least one electrically conductive strip to be printed and/or adhesively bonded onto the plastic line. Printable or adhesively bondable electrically conductive materials suitable for such an application are known to a person skilled in the art. These are therefore not discussed in further detail below.

Furthermore, the two-chamber line 14 can be designed to be flexible at least at its end 14′ facing the connection piece 16 by virtue of the fact that it is corrugated for instance in certain portions and/or its material choice is correspondingly selected.

Although exemplary embodiments have been elucidated in the above description, it should be noted that numerous modifications are possible. Furthermore, it should be noted that the exemplary embodiments are merely examples which are not intended to limit the scope of protection, the applications and the structure in any way. Instead, the above description gives a person skilled in the art a guideline for the implementation of at least one exemplary embodiment, wherein various changes may be made, especially with regard to the function and arrangement of the component parts described, without departing from the scope of protection as apparent from the claims and combinations of features equivalent thereto.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of de-sign choice. It is the intention, therefore, to be limited only as indicated by the scope of the claims appended hereto.

1-7. (canceled)

8. A connection piece configured to join a multi-chamber line of a fuel-carrying vehicle, comprising:
a common connection piece base section in which there are formed at least two mutually separated fuel-carrying lines comprising at least two mutually separated fuel-carrying lines;
a first fuel-carrying connection piece pipe section; and
a second fuel-carrying connection piece pipe section, wherein the first and the second fuel-carrying connection piece pipe sections are spaced apart from one another and integrally and formed on the common connection piece base section, and into which a respective assigned connection piece pipe section opens,
wherein the first fuel-carrying connection piece pipe section, in conjunction with a first line, carries a fuel in a first flow direction, and
wherein the second fuel-carrying connection piece pipe section, in conjunction with a second line, carries the fuel in the first flow direction or in a second flow direction opposite to the first flow direction.

9. The connection piece as claimed in claim 8, wherein the connection piece further comprises a third fuel-carrying connection piece pipe section, wherein respective individual connection piece pipe sections are spaced apart from one another and open into an assigned fuel-carrying line of the connection piece base section.

10. The connection piece as claimed in claim 8, wherein respective cross sections of the respective individual fuel-carrying connection piece pipe sections are asymmetrical to one another.

11. The connection piece as claimed in claim 10, wherein the cross sections of the individual connection piece pipe sections are one or more of circular, semi-circular, oval, semi-oval, triangular, square, rectangular, and half-moon-shaped.

12. The connection piece as claimed claim 8, wherein the connection piece is integrally formed on a flange configured to close an opening of a fuel tank of a fuel delivery unit.

13. An arrangement comprising:
a connection piece configured to join a multi-chamber line of a fuel-carrying vehicle, comprising:
a common connection piece base section in which there are formed at least two mutually separated fuel-carrying lines comprising at least two mutually separated fuel-carrying lines;
a first fuel-carrying connection piece pipe section; and
a second fuel-carrying connection piece pipe section, wherein the first and the second fuel-carrying connection piece pipe sections are spaced apart from one another and integrally and formed on the common connection piece base section, and into which a respective assigned connection piece pipe section opens,
wherein the first fuel-carrying connection piece pipe section, in conjunction with a first line, carries a fuel in a first flow direction,
wherein the second fuel-carrying connection piece pipe section, in conjunction with a second line, carries the fuel in the first flow direction or in a second flow direction opposite to the first flow direction; and
at least one fuel line configured as a one-piece multi-chamber line having at least two mutually separated fuel-carrying lines.

14. A fuel supply system of a vehicle, comprising:
a connection piece configured to join a multi-chamber line of a fuel-carrying vehicle, comprising:
a common connection piece base section in which there are formed at least two mutually separated fuel-carrying lines comprising at least two mutually separated fuel-carrying lines;
a first fuel-carrying connection piece pipe section; and
a second fuel-carrying connection piece pipe section, wherein the first and the second fuel-carrying connection piece pipe sections (18_{I}, 18_{II}) are spaced apart from one another and integrally and formed on the common connection piece base section (20, 20_{I}, 20_{II}), and into which a respective assigned connection piece pipe section opens,
wherein the first fuel-carrying connection piece pipe section, in conjunction with a first line, carries a fuel in a first flow direction,
wherein the second fuel-carrying connection piece pipe section, in conjunction with a second line, carries the fuel in the first flow direction or in a second flow direction opposite to the first flow direction; and
at least one fuel line configured as a one-piece multi-chamber line having at least two mutually separated fuel-carrying lines.
